(19) United States
(12) Patent Application Publication
(10) Pub. No.: US 2004/0169033 A1
(43) Pub. Date: Sep. 2, 2004

(54) Holder for use in semiconductor or liquid-crystal manufacturing device and semiconductor or liquid-crystal manufacturing device in which the holder is installed

(75) Inventors: Akira Kuibira, Itami-shi (JP); Masuhiro Natsuhara, Itami-shi (JP); Hirohiko Nakata, Itami-shi (JP)

Correspondence Address: JUDGE PATENT FIRM, RIVIERE SHUKUGAWA 3RD FL., 3-1 WAKAMATSU-CHO, NISHINOMIYA-SHI, HYOGO, 662-0035, JP

(73) Assignee: Sumitomo Electric Industries, Ltd., Osaka-shi (JP)

(21) Appl. No.: 10/708,301

(22) Filed: Feb. 23, 2004

(30) Foreign Application Priority Data
Feb. 27, 2003 (JP) JP-2003-050395

(51) Int. Cl. H05B 3/68

(52) U.S. Cl. 219/444.1

(57) ABSTRACT

Affords holders for semiconductor or liquid-crystal manufacturing devices—and semiconductor manufacturing devices in which the holders are installed—in which temperature uniformity in the processed-object retaining face of their resistive-heating-element containing ceramic susceptor is enhanced. By arranging a metal plate on a resistive-heating-element containing ceramic susceptor opposite its processed-object retaining side, the surface temperature of a semiconductor wafer or LCD glass being retained on the susceptor can be made uniform. Although simply setting the metal sheet on the ceramic susceptor is efficacious, fastening it by bonding, screws, snug-fitting, or vacuum adhesion further enhances the efficacy.

### BACKGROUND OF INVENTION

1. Field of the Invention

The present invention relates to holders employed in semiconductor manufacturing devices or in liquid-crystal manufacturing devices such as plasma-assisted CVD, low-pressure CVD, metal CVD, dielectric-film CVD, ion-implantation, etching, low-k film heat-treatment, and degassing heat-treatment devices, and furthermore to processing chambers and semiconductor or liquid-crystal manufacturing devices in which the holders are installed.

2. Description of the Background Art

Conventionally, in semiconductor or liquid-crystal manufacturing procedures various processes, such as film deposition processes and etching processes, are carried out on semiconductor substrates or liquid-crystal containing glass plates (LCD glass) that are the processed objects. Ceramic susceptors, which are both for retaining semiconductor substrates or LCD glass, and for heating semiconductor substrates or LCD glass, are used in the processing devices in which such processes on semiconductor substrates or LCD glass are carried out.

Japanese Unexamined Pat. App. Pub. No. H04-78138 for example discloses a conventional ceramic susceptor of this sort. The ceramic susceptor disclosed in H04-78138 includes: a heater part made of ceramic, into which a resistive heating element is embedded and that is provided with a wafer-heating surface, arranged within a chamber; a columnar support part that is provided on the side other than the wafer-heating side of the heater part, and that forms a gastight seal between it and the chamber; and electrodes connected to the resistive heating element and leading outside the chamber so as essentially not to be exposed to the chamber interior space.

Although this invention serves to remedy the contamination and poor thermal efficiency that had been seen with the metal heaters that had gone earlier, it does not touch upon temperature distribution in semiconductor substrates being processed. Nonetheless, semiconductor-substrate temperature distribution is crucial in that it proves to be intimately related to yield in the situations where the various processes just noted are carried out. Given the importance of temperature distribution, Japanese Unexamined Pat. App. Pub. No. 2001-118664, for example, discloses a ceramic susceptor capable of equalizing the temperature of its ceramic substrate. In terms of this invention, it is tolerable in practice that the temperature differential between the highest and lowest temperatures in the ceramic substrate surface be within in several %.

Scaling-up of semiconductor substrates as well as LCD glass has been moving forward in recent years, however. For example, with the silicon (Si) wafers that are semiconductor substrates, a transition from 8-inch to 12-inch is in progress. Likewise with LCD glass, scaling-up to an extremely large 1000 mm×500 mm is underway. Consequent on this enlarging of semiconductor substrates as well as LCD glass in diametric span, that the temperature distribution in the semiconductor-substrate retaining surface (heating surface) of ceramic susceptors be within ±1.0% has become a necessity; that it be within ±0.5% has, moreover, come to be the expectation.

Ceramics of high thermal conductivity are utilized as a means to improve temperature uniformity in the wafer-retaining side of ceramic susceptors. Heat issuing from the resistive heating element disperses readily through the susceptor interior if the ceramic thermal conductivity is high, making for enhanced temperature uniformity in the retaining surface.

Since current is passed through the resistive heating element to have it generate heat, the ceramic must be an electrical insulator. With ceramics that are insulative those that have high thermal conductivity are limited, however. For example, although diamond of 2000 W/mK thermal conductivity and c-BN (cubic boron nitride) of 500 W/mK are available, with either of these being a material that can be procured only under ultra-high pressure and temperature conditions they are extraordinarily high-priced and there is a limit to their manufacturable size; thus they cannot be utilized in a ceramic susceptor that is the object of the present invention.

Another means to improve temperature uniformity is to lay a layer of metal, which is higher in thermal conductivity than ceramic, onto a ceramic susceptor and to heat via the metal an object being treated, whereby the heat issuing from the resistive heating element will diffuse also along the susceptor surface (horizontally), and thus the treated object can be heated more uniformly. Metals of high thermal conductivity include, for example: silver (Ag), which is 428 W/mK in thermal conductivity; copper (Cu), which is 403 W/mK; and aluminum (Al), which is 236 W/mK.

Compared with ceramics, however, metals are inferior in resistance to corrosion, and thus if metal is employed atop ceramic, reaction gas for when semiconductor wafers and LCD glass are processed will react also with the metal, producing corrosion in the metal and generating metal impurities and particles, which has a negative impact on the semiconductor substrates and LCD glass.

### SUMMARY OF INVENTION

The present invention has been brought about to solve the problems discussed above. Namely, an object of the present invention is to make available inexpensive holders for semiconductor or liquid-crystal manufacturing devices—and to make available semiconductor or liquid-crystal manufacturing devices in which the holders are installed—in which temperature uniformity in the surface of the semiconductor wafer or LCD glass is enhanced and generation of particles is slight.

In a holder of the present invention for semiconductor or liquid-crystal manufacturing devices a metal plate is arranged on the side of a resistive-heating-element containing ceramic susceptor opposite the susceptor's processed-object retaining side. Such a configuration enables the surface temperature of a semiconductor wafer or LCD glass being retained on the ceramic susceptor to be made uniform.

Although the metal plate and ceramic susceptor will function with the ceramic susceptor simply set atop the metal sheet, advantageously the metal plate and ceramic susceptor are fastened by bonding, screws, snug-fitting, or vacuum adhesion. Also desirable is that the resistive heating element be present beyond the middle along the susceptor thickness, toward the side opposite the retaining side.

The susceptor ceramic advantageously is any ceramic selected from Al₂O₃, SiO₂, B₄C and BN; and in order to enhance its temperature uniformity further, the thermal conductivity of the ceramic advantageously is 100 W/mK or more. It is desirable that the ceramic having a thermal conductivity of 100 W/mK or more be any ceramic selected from AlN, SiC and Si₃N₄.

The thermal conductivity of the plate metal advantageously is 100 W/mK or more; it is desirable that such metal be any metal selected from Al—SiC, Cu—W and Cu—Mo.

Another advantage is to have the thickness of the metal plate be thicker than the thickness of the ceramic susceptor. Likewise, the diameter of the susceptor preferably is 200 mm or more, while the porosity of the susceptor ceramic preferably is 0.03% or less. Furthermore, warpage in the retaining side of the ceramic susceptor preferably is 500 □m or less.

A holder of the present invention in a semiconductor manufacturing device preferably heats wafers, and in a liquid-crystal manufacturing device preferably heats glass substrates.

In semiconductor manufacturing devices and liquid-crystal manufacturing devices in which a holder of this sort is installed, because surface temperature of the wafers or LCD glass that are the objects processed proves to be more uniform than conventional, semiconductor or liquid-crystal display devices can be produced at excellent yield rate s.

From the following detailed description in conjunction with the accompanying drawings, the foregoing and other objects, features, aspects and advantages of the present invention will become readily apparent to those skilled in the art.

### BRIEF DESCRIPTION OF DRAWINGS

FIG. 1 illustrates the cross-sectional structure of an example of a holder of the present invention; and

FIGS. 2 through 5 each illustrate the cross-sectional structure of respectively different examples of holders of the present invention.

### DETAILED DESCRIPTION

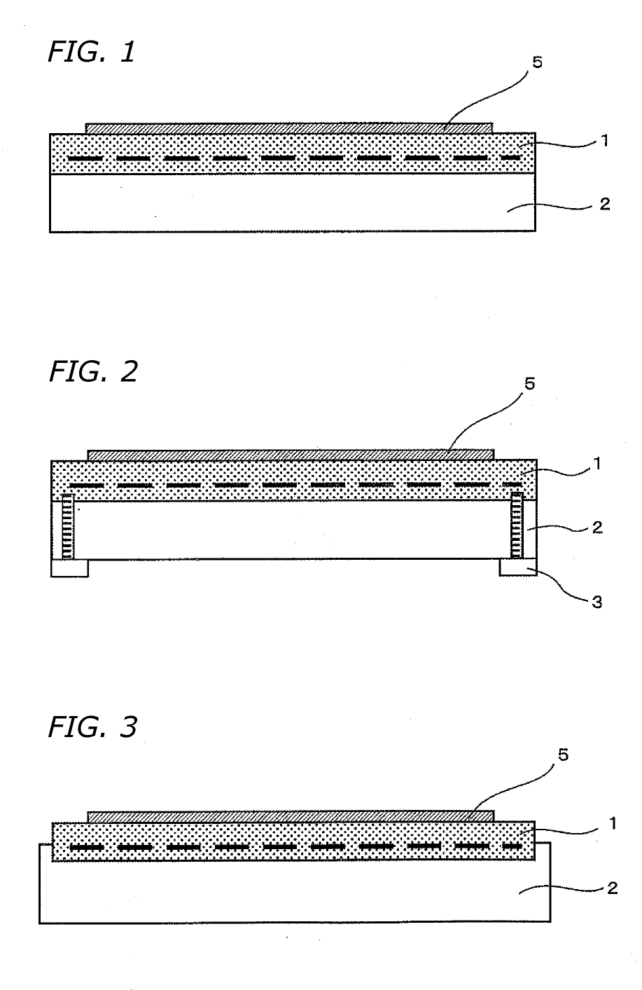

The present inventors discovered as the cumulative result of concerted investigations that rendering a holder to be, as represented in FIG. 1, a resistive-heating-element including ceramic susceptor 1 for retaining an object 5 to be processed, configured so as to have a metal plate 2 on the side opposite the processed-object retaining side, significantly improved temperature uniformity in the surface of the processed object.

The heat generated by the resistive heating element diffuses not only to the retaining side, but also to the susceptor side opposite the retaining side. Heat that has diffused to the opposite side is not only emitted from the surface there, but is also reflected by that opposite surface, diffusing toward the retaining side. Therein it was found that the thermal conductivity of the material arranged directly beneath the opposite surface being high, making heat reflect more uniformly along the surface, promotes heat diffusion toward the retaining side to further enhance the temperature uniformity of the retaining side. As a result it was discovered that, as just noted, a holder configured so as to have, atop a metal plate, a resistive-heating-element including ceramic susceptor for retaining an object to be processed made for significantly improved temperature uniformity in the surface of the processed object.

Inasmuch as the metal plate is arranged on the side of the ceramic susceptor opposite the retaining side, reducing contact between the aforementioned reaction gasses and the metal to the utmost, the previously noted generation of metal impurities and particles is held in check. With the semiconductor-wafer and LCD-glass process yield being therefore improved, holders of the present invention are optimal for scale-up of semiconductor wafers and LCD glass.

Although a structure in which the ceramic susceptor is set atop the metal plate is efficacious, a structure where the metal plate and the ceramic susceptor are fastened by a method such as bonding, screws, snug-fitting, or vacuum adhesion is preferable in that it proves to be more isothermal. Furthermore, disposing the resistive heating element beyond the middle along the susceptor thickness, toward the side opposite the retaining side, is advantageous in that it further enhances the temperature uniformity.

Preferable susceptor ceramics are, from heat-resistance and corrosion-resistance viewpoints, Al₂O₃, SiO₂, B₄C, BN or the like. And from a temperature-uniformity point of view, ceramics whose thermal conductivity is 100 W/mK or more are to be preferred, while preferable as such ceramics are AlN, SiC and Si₃N₄, or the like.

The higher the thermal conductivity of the metal is, the more uniform along the susceptor surface (horizontally) will be the heat that comes reflected from the side opposite the retaining side, improving the temperature uniformity; but a thermal conductivity of 100 W/mK or more for the metal is advantageous since it will contribute to improving the temperature uniformity. And with inexpensive metals whose thermal expansion coefficient is close to that of ceramics and that are superior in corrosion resistance being preferred, Al—SiC, Cu—W and Cu—Mo are advantageous as such metals.

The thinner a ceramic is less expensive it will be. The thicker the metal plate, the more enhanced the isothermal efficacy will be. Accordingly, to make a holder inexpensive and superior in temperature uniformity, the thickness of the metal plate preferably is thicker than the thickness of the ceramic susceptor. In turn, since it produces outstanding temperature uniformity, a holder of the present invention enables particular efficacy to be demonstrated—and is therefore optimal—in the case of ceramic susceptors of 200 mm or greater diameter that are utilized for large-scale semiconductor wafers and large-scale liquid-crystal substrates.

Another consideration is that with pores being present in the ceramic, in a vacuum or within a reduced-pressure environment gases issue forth from the pores, and thus when a vacuum is being drawn it takes time to attain the required vacuum level, prolonging the total process time and lowering the effective throughput. Although it would thus be better that pores not be present, a ceramic porosity of 0.03% or less is acceptable because there will be almost no influence on the throughput.

A still further consideration is that semiconductor wafers and LCD glass are heated with the wafers and glass being held on the retaining side of the ceramic susceptor, and if the degree of planarization of the retaining side is poor, the transmission of heat to the object being processed will be non-uniform, worsening the temperature distribution in the surface of the processed object; and although it would thus be better that the retaining side be flat, a warpage of 500 □m or less is acceptable because it will have almost no impact on the temperature uniformity of the processed-object surface.

Ceramics that can be utilized in the present invention are ceramics superior in corrosion resistance and whose thermal conductivity is satisfactory. In the following, a method of manufacturing in the case of aluminum nitride (AlN) as an example of such a ceramic will be described in detail.

AlN raw material powder whose specific surface area is 2.0 to 5.0 m²/g is preferable. The sinterability of the aluminum nitride declines if the specific surface area is less than 2.0 m²/g. Handling proves to be a problem if on the other hand the specific surface area is over 5.0 m²/g, because the powder coherence becomes extremely strong. Furthermore, the quantity of oxygen contained in the raw-material powder is preferably 2 wt. % or less. In sintered form, the thermal conductivity of the material deteriorates if the oxygen quantity is in excess of 2 wt. %. It is also preferable that the amount of metal impurities other than aluminum contained in the raw-material powder be 2000 ppm or less. The thermal conductivity of a sintered compact of the powder deteriorates if the amount of metal impurities exceeds this range. In particular, the content respectively of Group IV elements such as Si, and elements of the iron family, such as Fe, which as metal impurities have a serious worsening effect on the thermal conductivity of a sintered compact, is advisably 500 ppm or less.

Because AlN is not a readily sinterable material, adding a sintering promoter to the AlN raw-material powder is advisable. The sintering promoter added preferably is a rare-earth element compound. Since rare-earth element compounds during sintering react with aluminum oxides or aluminum oxynitrides present on the surface of the particles of the aluminum nitride powder, acting to promote densification of the aluminum nitride and to eliminate oxygen being a causative factor that worsens the thermal conductivity of the aluminum nitride sintered part, they enable the thermal conductivity of the aluminum nitride sintered part to be improved.

Yttrium compounds, whose oxygen-eliminating action is particularly pronounced, are preferable rare-earth element compounds. The amount added is preferably 0.01 to 5 wt. %. If less than 0.01 wt. %, producing ultrafine sintered materials is problematic, along with which the thermal conductivity of the sintered parts deteriorates. Added amounts in excess of 5 wt. % on the other hand lead to sintering promoter being present at the grain boundaries in the aluminum nitride sintered part, and consequently, if the compact is employed under a corrosive atmosphere, the sintering promoter present along the grain boundaries gets etched, becoming a source of loosened grains and particles. More preferably the amount of sintering promoter added is 1 wt. % or less. Being less than 1 wt. %, the sintering promoter will no longer be present even at the grain boundary triple points, which improves the corrosion resistance.

To characterize the rare-earth compounds further: oxides, nitrides, fluorides, and stearic oxide compounds may be employed. Among these, oxides, being inexpensive and readily obtainable, are preferable. By the same token, stearic oxide compounds are especially suitable since they have a high affinity for organic solvents, and if the aluminum nitride raw-material powder, sintering promoter, etc. are to be mixed together in an organic solvent, the fact that the sintering promoter is a stearic oxide compound will heighten the miscibility.

Next, a predetermined volume of solvent, a binder, and further, a dispersing agent or a coalescing agent as needed, are added to the aluminum nitride raw-material powder and powdered sintering promoter, and the mixture is blended together. Possible mixing techniques include ball-mill mixing and mixing by ultrasound. Mixing techniques of this sort allow a raw-material slurry to be produced.

The obtained slurry is molded, and the molded product is sintered to yield a sintered aluminum-nitride part. Co-firing and metallization are two possible methods as a way of doing this.

Metallization will be described first. Granules are prepared from the slurry by spray-drying it, or by means of a similar technique. The granules are inserted into a predetermined mold and subject to press-molding. The pressing pressure therein desirably is 0.1 t/cm² or more. With pressure less than 0.1 t/cm², sufficient strength in the molded piece cannot be produced in most cases, making the piece liable to break in handling.

Although the density of the molded piece will differ depending on the amount of binder contained and on the amount of sintering promoter added, the density is preferably 1.5 g/cm³ or more. A density of less than 1.5 g/cm³ would mean a relatively large distance between particles in the raw-material powder, which would hinder the progress of the sintering. At the same time, the molded product density preferably is 2.5 g/cm³ or less. Densities of more than 2.5 g/cm³ would make it difficult to eliminate sufficiently the binder from within the molded product in the degreasing process of the ensuing manufacturing procedure. It would consequently prove difficult to produce an ultrafine sintered part as described earlier.

Next, the molded product is heated within a non-oxidizing atmosphere to put it through a degreasing process. Carrying out the degreasing process under an oxidizing atmosphere such as air would degrade the thermal conductivity of the sinter, because the AlN powder would become superficially oxidized. For the non-oxidizing ambient gases, nitrogen and argon are preferable. The heating temperature in the degreasing process is preferably 500° C. or more and 1000° C. or less. With temperatures of less than 500° C., carbon is left remaining in excess within the laminate following the degreasing process because the binder cannot sufficiently be eliminated, which interferes with sintering in the subsequent sintering procedure. On the other hand, at temperatures of more than 1000° C., the amount of carbon left remaining turns out to be too little, such that the ability to eliminate oxygen from the oxidized coating superficially present on the surface of the AlN powder is compromised, degrading the thermal conductivity of the sintered part.

Another condition is that the amount of carbon left remaining within the molded product after the degreasing process is preferably 1.0 wt. % or less. Since carbon remaining in excess of 1.0 wt. % interferes with sintering, an ultrafine sintered part cannot be produced.

Next, sintering is carried out. The sintering is carried out within a non-oxidizing nitrogen, argon, or like atmosphere, at a temperature of 1700 to 2000° C. Therein the moisture contained in the ambient gas such as nitrogen that is employed is preferably −30° C. or less given in dew point. If the atmosphere were to contain more moisture than this, the thermal conductivity of the sintered part would likely be compromised, because the AlN would react with the moisture within the ambient gas during sintering and form nitrides. Another preferable condition is that the volume of oxygen within the ambient gas be 0.001 vol. % or less. A larger volume of oxygen would lead to a likelihood that the AlN would oxidize, impairing the thermal conductivity of the sintered part.

As another condition during sintering, the jig employed is suitably a boron nitride (BN) molded part. Inasmuch as the jig as a BN molded part will be sufficiently heat resistant against the sintering temperatures, and superficially will have solid lubricity, friction between the jig and the laminate when the laminate contracts during sintering will be lessened, which will enable sinter products with little distortion to be produced.

The obtained sintered part is subjected to processing according to requirements. In cases where a conductive paste is to be screen-printed onto the sintered part in the ensuing manufacturing steps, the surface roughness is preferably 5 □m or less in Ra. If over 5 □m, in screen printing to form a circuit on the compact, defects such as blotting or pinholes in the pattern are liable to arise. More suitable is a surface roughness of 1 □m or less in Ra.

In polishing to the abovementioned surface roughness, although cases in which screen printing is done on both sides of the sintered part are a matter of course, even in cases where screen printing is effected on one side only, the polishing process should also be carried out on the surface on the side opposite the screen-printing face. This is because polishing only the screen-printing face would mean that during screen printing, the sintered part would be supported on the unpolished face, and in that situation burrs and debris would be present on the unpolished face, destabilizing the fixedness of the sintered part such that the circuit pattern might not be drawn well by the screen printing.

Furthermore, at this point the thickness uniformity (parallelism) between the processed faces is preferably 0.5 mm or less. Thickness uniformity exceeding 0.5 mm can lead to large fluctuations in the thickness of the conductive paste during screen printing. Particularly suitable is a thickness uniformity of 0.1 mm or less. Another preferable condition is that the planarity of the screen-printing face be 0.5 mm or less. If the planarity exceeds 0.5 mm, in that case too there can be large fluctuations in the thickness of the conductive paste during screen printing. Particularly suitable is a planarity of 0.1 mm or less.

Screen printing is used to spread a conductive paste and form the electrical circuits onto the sintered part having undergone the polishing process. The conductive paste can be obtained by mixing together with a metal powder an oxide powder, a binder, and a solvent according to requirements. The metal powder is preferably tungsten, molybdenum or tantalum, since their thermal expansion coefficients match those of ceramics.

Adding the oxide powder to the conductive paste is also to enhance the strength with which it bonds to AlN. The oxide powder preferably is an oxide of Group IIa or Group IIIa elements, or is Al₂O₃, SiO₂, or a like oxide. Yttrium oxide is especially preferable because it has very good wettability with AlN. The amount of such oxides added is preferably 0.1 to 30 wt. %. If the amount is less than 0.1 wt. %, the bonding strength between AlN and the metal layer being the circuit that has been formed is compromised. On the other hand, amounts in excess of 30 wt. % make the electrical resistance of the circuit metal layer high.

The thickness of the conductive paste is preferably 5 □m or more and 100 □m or less in terms of its post-drying thickness. If the thickness is less than 5 □m the electrical resistance would be too high and the bonding strength would decline. Likewise, if in excess of 100 □m the bonding strength would be compromised in that case as well.

Also preferable is that in the patterns for the circuits that are formed, in the case of the heater circuit (resistive heating element circuit), the pattern spacing be 0.1 mm or more. With a spacing of less than 0.1 mm, shorting will occur when current flows in the resistive heating element and, depending on the applied voltage and the temperature, leakage current is generated. Particularly in cases where the circuit is employed at temperatures of 500° C. or more, the pattern spacing preferably should be 1 mm or more; more preferable still is that it be 3 mm or more.

After the conductive paste is degreased, baking follows. Degreasing is carried out within a non-oxidizing nitrogen, argon, or like atmosphere. The degreasing temperature is preferably 500° C. or more. At less than 500° C., elimination of the binder from the conductive paste is inadequate, leaving behind carbon in the metal layer that when baked will form metal carbides and consequently raise the electrical resistance of the metal layer.

The baking is suitably done within a non-oxidizing nitrogen, argon, or like atmosphere at a temperature of 1500° C. or more. At temperatures of less than 1500° C., the post-baking electrical resistance of the metal layer turns out too high because the baking of the metal powder within the paste does not proceed to the grain growth stage. A further baking parameter is that the baking temperature should not surpass the sintering temperature of the ceramic produced. If the conductive paste is baked at a temperature beyond the sintering temperature of the ceramic, dispersive volatilization of the sintering promoter incorporated within the ceramic sets in, and moreover, grain growth in the metal powder within the conductive paste is accelerated, impairing the bonding strength between the ceramic and the metal layer.

Next, in order to ensure that the formed metal layer is electrically isolated, an insulative coating can be formed on the metal layer. Preferably the insulative coating substance is the same substance as the ceramic on which the metal layer is formed. Problems such as post-sintering warpage arising from the difference in thermal expansion coefficients will occur if the ceramic and insulative coating substances differ significantly. For example, in a case where the ceramic is AlN, a predetermined amount of an oxide/carbide of a Group IIa element or a Group IIIa element can be added to and mixed together with AlN powder, a binder and a solvent added and the mixture rendered into a paste, and the paste can be screen-printed to spread it onto the metal layer.

In that case, the amount of sintering promoter added preferably is 0.01 wt. % or more. With an amount less than 0.01 wt. % the insulative coating does not densify, making it difficult to secure electrical isolation of the metal layer. It is further preferable that the amount of sintering promoter not exceed 20 wt. %. Surpassing 20 wt. % leads to excess sintering promoter invading the metal layer, which can end up altering the metal-layer electrical resistance. Although not particularly limited, the spreading thickness preferably is 5 □m or more. This is because securing electrical isolation proves to be problematic at less than 5 □m.

Next, in the present method, the ceramic as substrates furthermore can be laminated according to requirements. Lamination may be done via a bonding agent. The bonding agent—being a compound of Group IIa or Group IIIa elements, and a binder and solvent, added to an aluminum oxide powder or aluminum nitride powder and made into a paste—is spread onto the bonding surface by a technique such as screen printing. The thickness of the applied bonding agent is not particularly restricted, but preferably is 5 □m or more. Bonding defects such as pinholes and bonding irregularities are liable to arise in the bonding layer with thicknesses of less than 5 □m.

The ceramic substrates onto which the bonding agent has been spread are degreased within a non-oxidizing atmosphere at a temperature of 500° C. or more. The ceramic substrates are thereafter bonded to one another by stacking together the ceramic substrates to be laminated, applying a predetermined load to the stack, and heating it within a non-oxidizing atmosphere. The load preferably is 0.05 kg/cm² or more. With loads of less than 0.05 kg/cm² sufficient bonding strength will not be obtained, and otherwise the bonding defects just note will be prone to occur.

Although the heating temperature for bonding is not particularly restricted as long as it is a temperature at which the ceramic substrates adequately bond to one another via the bonding layers, preferably it is 1500° C. or more. With adequate bonding strength proving difficult to gain at less than 1500° C., defects in the bond are liable to arise. Nitrogen or argon is preferably employed for the non-oxidizing atmosphere during the degreasing and bonding just discussed.

A ceramic sinter laminate that serves as a ceramic susceptor thus can be produced as in the foregoing. As far as the electrical circuits are concerned, it should be understood that if they are heater circuits for example, then a molybdenum coil can be utilized, and in cases such as with electrostatic-chuck electrode circuits and high-frequency power-generating electrode circuits, molybdenum or tungsten mesh can be, without employing conductive paste.

In such cases, the molybdenum coil or the mesh can be built into the AlN raw-material powder, and the susceptor can be fabricated by hot pressing. While the temperature and atmosphere in the hot press may be on par with the AlN sintering temperature and atmosphere, the hot press desirably applies a pressure of 10 kg/cm² or more. With pressure of less than 10 kg/cm², the ceramic susceptor might not demonstrate its performance capabilities, because interstices arise between the AlN and the molybdenum coil or the mesh.

Co-firing will now be described. The earlier-described raw-material slurry is molded into sheets by doctor blading. The sheet-molding parameters are not particularly limited, but the post-drying thickness of the sheets advisably is 3 mm or less. The sheet thickness surpassing 3 mm leads to large shrinkage in the drying slurry, raising the probability that fissures will be generated in the sheet.

A metal layer of predetermined form that serves as an electrical circuit is formed onto an abovementioned sheet using a technique such as screen printing to spread onto it a conductive paste. The conductive paste utilized can be the same as that which was descried under the metallization method. Nevertheless, not adding an oxide powder to the conductive paste does not hinder the co-firing method.

Subsequently, the sheet that has undergone circuit formation is laminated with sheets that have not. Lamination is by setting the sheets each into predetermined position to stack them together. Therein, according to requirements, a solvent is spread on between sheets. In the stacked state, the sheets are heated as may be necessary. In cases where the stack is heated, the heating temperature is preferably 150° C. or less. Heating to temperatures in excess of this greatly deforms the laminated sheets. Pressure is then applied to the stacked-together sheets to unitize them. The applied pressure is preferably within a range of from 1 to 100 MPa. At pressures less than 1 MPa, the sheets are not adequately unitized and can peel apart during subsequent manufacturing steps. Likewise, if pressure in excess of 100 MPa is applied, the extent to which the sheets deform becomes too great.

This laminate undergoes a degreasing process as well as sintering, in the same way as with the metallization method described earlier. Parameters such as the temperature in degreasing and sintering and the amount of carbon are the same as with metallization. A ceramic susceptor having a plurality of electrical circuits can be readily fabricated by printing, in the previously described screen printing of a conductive paste onto sheets, heater circuits, electrostatic-chuck electrodes, etc. respectively onto a plurality of sheets and laminating them. In this way a ceramic sinter laminate that serves as a ceramic susceptor can be produced.

The obtained ceramic sinter laminate is subject to processing according to requirements. As a rule, in the sintered state the ceramic sinter laminate usually is not within the precision demanded in semiconductor manufacturing devices. The planarity of the wafer-carrying side as an example of processing precision is preferably 0.5 mm or less; moreover 0.1 mm or less is particularly preferable. The planarity surpassing 0.5 mm is apt to give rise to interstices between the ceramic susceptor and a wafer the susceptor carries, keeping the heat of the susceptor from being uniformly transmitted to the wafer and making the generation of temperature irregularities in the wafer likely.

A further preferable condition is that the surface roughness of the wafer-carrying side be 5 □m in Ra. If the roughness is over 5 □m in Ra, grains loosened from the AlN due to friction between the ceramic susceptor and the wafer can grow numerous. Grain-loosened particles in that case become contaminants that have a negative effect on processes, such as film deposition and etching, on the wafer. Furthermore, then, a surface roughness of 1 □m or less in Ra is ideal.

Subsequently, electrodes are attached to the ceramic susceptor. The attaching can be done according to publicly known techniques. For example, the side of the ceramic susceptor opposite its processed-object-retaining face may be spot faced through to the electrical circuit, and metallization to the circuit carried out, or without metallizing, electrodes of molybdenum, tungsten, etc. may be connected to the circuit directly using activated metal brazing material. The electrodes can thereafter be plated as needed to improve their resistance to oxidation. In this way, a holder for semiconductor as well as liquid-crystal manufacturing devices can be fabricated.

Moreover, semiconductor wafers can be processed on a ceramic susceptor according to the present invention, integrated into a semiconductor manufacturing device. Inasmuch as the temperature of the wafer-retaining face of a ceramic susceptor by the present invention is uniform, the temperature distribution in the wafer will be more uniform than is conventional, to yield stabilized characteristics in terms of deposited films, heating processes, etc.

In addition, LCD glass can be processed on a ceramic susceptor according to the present invention, integrated into a semiconductor manufacturing device. Inasmuch as the temperature of the LCD-glass-retaining face of a ceramic susceptor by the present invention is uniform, the temperature distribution in the LCD glass surface will be more uniform than is conventional, to yield stabilized characteristics in terms of deposited films, heating processes, etc.

Embodiments

Embodiment 1— A granulated powder was prepared by mixing 99.5 parts by weight aluminum nitride powder and 0.5 parts by weight Y₂O₃ powder and blending with polyvinyl butyral as a binder, and then spray-drying the mixture to granulate it. Here, an aluminum nitride powder having a mean particle diameter of 0.6 □m and a specific surface area of 3.4 m²/g was used. The granules were charged into a mold, sintered and processed, and then a uniaxial press was employed to mold processed parts to dimensions such that they would be 350 mm diameter, 17 mm thickness, and 350 mm diameter, 2 mm thickness. The molded parts were degreased within a nitrogen atmosphere at 900° C., and sintered 5 hours within a nitrogen atmosphere at 1900° C. The thermal conductivity of the obtained sintered parts was 170 W/mK, while the porosity was 0.01%. The sintered parts were put through a polishing operation using a diamond abrasive to produce sintered ceramic parts of the two dimensional categories just noted.

In addition, a tungsten paste was prepared with a tungsten powder of 2.0 □m mean particle diameter being 100 parts by weight, and utilizing Y₂O₃ at 1 part by weight, 5 parts by weight ethyl cellulose, being a binder, and as a solvent, butyl Carbitol™. A pot mill and a triple-roller mill were used for blending the mixture. This tungsten paste was formed into a heater circuit pattern onto the above-noted sintered part of 17 mm thickness by screen-printing, and then the printed paste was fired onto the part by heating it 1 hour at 1850° C.

Furthermore, a kneaded mixture of a bonding glass into which ethyl cellulose had been added was spread onto on the surface of the above-noted sintered part of 2 mm thickness. This were degreased at 900° C. within a nitrogen atmosphere, and then the heater-circuit side of the sintered part onto which a heater circuit had been fired was mated with the side of the one onto which the bonding glass had been spread, and the two-ply sintered part was bonded together and heated 2 hours at 1800° C. while being subjected to a pressure of 4.9 Pa (5 ton/cm²) to produce a ceramic susceptor. The degree of planarization in the processed-object retaining surface of the ceramic susceptor obtained was 50 □m.

The heater circuit in the susceptor was partially exposed by spot-facing in two places through the side opposite the processed-object retaining side, as far as the heater circuit. An active metal brazing material was used to join electrodes made of tungsten directly to the exposed portions of the heater circuit. In addition, a metal plate of 350 mm diameter and 10 mm thickness was machined from Al—SiC having a thermal conductivity of 210 W/mK, and was arranged on the underside of the ceramic susceptor. The susceptor was heated by passing current through the electrodes, and its temperature uniformity was measured. Assaying temperature uniformity was by placing a 12-inch wafer temperature gauge on the wafer-retaining face and measuring its temperature distribution. Here the supplied electric power was adjusted so that the temperature in the midportion of the wafer temperature gauge would be 500° C. The result was a temperature uniformity of ±0.5%. An in-line test on 50 12-inch diameter silicon wafers was run, wherein there was no appreciable generation of metal impurities or particles.

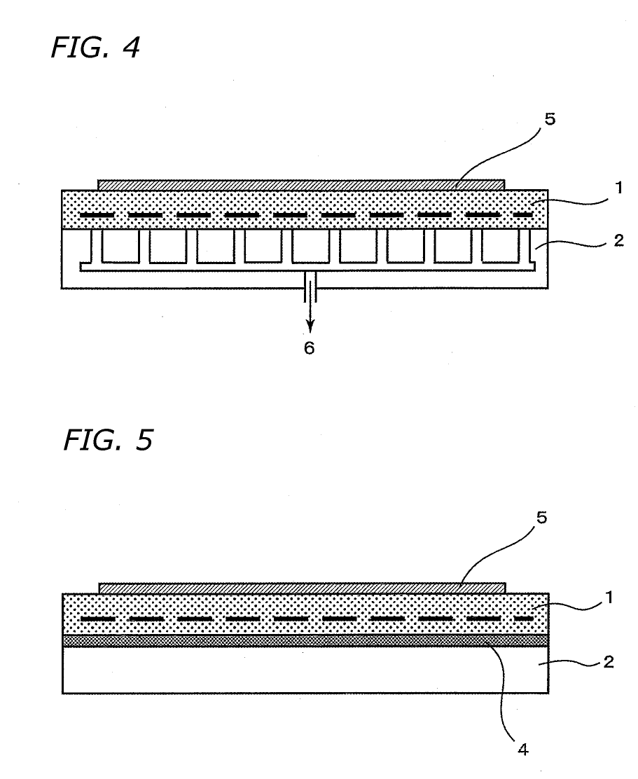

Embodiment 2—Ceramic susceptors and metal plates the same as in Embodiment 1 were utilized to prepare a holder in which the two were fastened with screws 3 as depicted in FIG. 2, one in which they were fastened by snug-fitting as depicted in FIG. 3, one in which they were fastened by vacuum adhesion 6 as depicted in FIG. 4, and one in which they were fastened by a glass joint 4 as depicted in FIG. 5. The temperature uniformity at 500° C. of these holders was measured using a wafer temperature gauge in the same way as in Embodiment 1. The results are set forth in Table I. Here, in Table I the result from Embodiment 1 is added in, set forth as “No. 1.”

TABLE I

| No. | Fastening method | Temperature uniformity (%) |
|---|---|---|
| 1 | None | ±0.50 |
| 2 | Screws | ±0.45 |
| 3 | Snug-fitting | ±0.45 |
| 4 | Vacuum adhesion | ±0.45 |
| 5 | Glass bonding | ±0.40 |

As will be understood from Table I, the temperature uniformity of the holders in which the ceramic susceptor and the metal plate were fastened by any of the methods was better than that in which they were not fastened. And with whichever of the fastening methods, as was the case in Embodiment 1, there was no appreciable generation of metal impurities or particles.

Embodiment 3—A ceramic susceptor was prepared in the same way as in Embodiment 1. However, two 7.5-mm plies were used for the thickness of the AlN sintered part. That is, whereas in Embodiment 1, the heater circuit was in a position 17 mm from the retaining face of the ceramic susceptor, in the present embodiment, the circuit was positioned to be in the middle along the thickness of the ceramic susceptor.

Utilizing this ceramic susceptor, a holder (No. 6) was rendered by glass bonding in the same way as in Embodiment 2, and its temperature uniformity at 500° C. was measured in the same manner as in Embodiment 1. The results were that while there was no discernible generation of metal impurities or particles, the temperature uniformity, at ±0.5%, was inferior to that of No. 5 in Embodiment 2.

Embodiment 4—Ceramic susceptors were prepared in the same way as in Embodiment 1, except that utilized instead of the AlN sintered parts were—all commercially available—an Al₂O₃ sintered part of 30 W/mK thermal conductivity; an SiO₂ sintered part of 1.4 W/mK thermal conductivity; a B₄C sintered part of 46 W/mK thermal conductivity; a BN sintered part of 40 W/mK thermal conductivity; an SiC sintered part of 100 W/mK thermal conductivity; and an Si₃N4 sintered part of 80 W/mK thermal conductivity. Holders were prepared by screw-fastening the same Al—SiC metal plate as in Embodiment 1 onto each ceramic susceptor. The temperature uniformity at 500° C. of each holder was measured in the same way as in Embodiment 1. The results are set forth in Table II.

TABLE II

| | | Thermal | | | | |
|---|---|---|---|---|---|---|
| | | conductivity | | Warpage | Fastening | Temp. uniformity |
| No. | Substance | (W/mK) | Porosity (%) | (μm) | method | (%) |
| 7 | Al₂O₃ | 30 | 0.01 | 50 | Screw fastening | ±0.7 |
| 8 | SiO₂ | 1.4 | 0.01 | 50 | Screw fastening | ±0.95 |
| 9 | B₄C | 46 | 0.01 | 50 | Screw fastening | ±0.6 |
| 10 | BN | 40 | 0.01 | 50 | Screw fastening | ±0.65 |
| 11 | SiC | 100 | 0.01 | 50 | Screw fastening | ±0.45 |
| 12 | Si₃N | 80 | 0.01 | 50 | Screw fastening | ±0.55 |

Temperature uniformity with whichever of the holders was within ±1.0%, but the temperature uniformity was within ±0.5% in the case where SiC whose thermal conductivity was 100 W/mK was utilized. Here, in instances where whichever of the holders was put to work, likewise as with Embodiment 1, there was no appreciable generation of metal impurities or particles.

Embodiment 5—AlN ceramic susceptors were prepared in the same way as in Embodiment 1. Except for utilizing instead of the Al—SiC metal plate a CuW plate of 250 W/mK thermal conductivity, and a CuMo plate of 210 W/mK thermal conductivity—each commercially available—holders were prepared by screw-fastening the plates to the ceramic susceptors in the same way as in Embodiment 2. The temperature uniformity at 500° C. of each holder was measured in the same way as in Embodiment 1. The results are set forth in Table III.

TABLE III

| | | Thermal | | Temp. |
|---|---|---|---|---|
| | | conductivity | Fastening | uniformity |
| No. | Substance | (W/mK) | method | (%) |
| 13 | CuW | 250 | Screw fastening | ±0.42 |
| 14 | CuMo | 210 | Screw fastening | ±0.45 |

Temperature uniformity with whichever of the holders was within ±0.5%, but at ±0.42% the CuW, whose thermal conductivity was 250 W/mK, excelled in temperature uniformity. Here, in situations where either of the holders was employed, likewise as with Embodiment 1, there was no discernible generation of metal impurities or particles.

Embodiment 6—Ceramic susceptors were prepared in the same way as in Embodiment 1, and to them Al—SiC metal plates were screw-fastened likewise as in Embodiment 2. Holders in which, however, the thickness of the Al—SiC metal plates and the size of the sintered AlN parts were changed as indicated in Table IV were prepared, and their temperature uniformity at 500° C. was measured likewise as in Embodiment 1. The results are set forth in Table IV.

TABLE IV

| | | Al—SiC | | | | |
|---|---|---|---|---|---|---|
| | AIN outer | thickness | | Warpage | Fastening | Temp. uniformity |
| No. | dia. (mm) | (mm) | Porosity (%) | (μm) | method | (%) |
| 15 | 350 | 6 | 0.01 | 50 | Screw fastening | ±0.49 |
| 16 | 350 | 4 | 0.01 | 50 | Screw fastening | ±0.55 |
| 17 | 220 | 10 | 0.01 | 50 | Screw fastening | ±0.43 |
| 18 | 180 | 10 | 0.01 | 50 | Screw fastening | ±0.42 |

Temperature uniformity with whichever of the holders was within ±1.0%, but the temperature uniformity where the thickness of the Al—SiC metal plate was thin compared with No. 2 of Embodiment 2 was poorer than ±0.45%. In addition, it is evident that the temperature uniformity turns out better when the outer diameter of the ceramic susceptor becomes smaller. Here, in instances where whichever of the holders was put to work, likewise as with Embodiment 1, generation of neither metal impurities nor particles could be identified.

Embodiment 7-Ceramic susceptors were prepared in the same way as in Embodiment 1, and to them Al—SiC metal plates were screw-fastened likewise as in Embodiment 2. However, sintered AlN parts in which the AlN sintering conditions were altered as indicated in Table V were utilized. The temperature uniformity at 500° C. of the holders was measured likewise as in Embodiment 1. The results are set forth in Table V. Here, for comparison No. 2 from Embodiment 2 is added in and set forth in Table V.

TABLE V

| | Sintering | Sintering | | Warpage | Fastening | Temp. uniformity |
|---|---|---|---|---|---|---|
| No. | temp. (° C.) | time (hours) | Porosity (%) | (μm) | method | (%) |
| 2 | 1900 | 5 | 0.01 | 50 | Screw fastening | ±0.45 |
| 19 | 1900 | 3 | 0.05 | 50 | Screw fastening | ±0.45 |
| 20 | 1900 | 1 | 0.10 | 50 | Screw fastening | ±0.45 |

Although there was no difference in the status of temperature uniformity nor of metal-impurity or particle generation, as FIG. 5 suggests, whereas with No. 2 the time required to pump down to a vacuum of 1 Pa (0.01 torr) was 10 minutes, with No. 19 it was 1 hour, and with No. 20, 2 hours, wherein it is evident that it takes time to draw a vacuum when the porosity is large.

Embodiment 8—Ceramic susceptors were prepared in the same way as in Embodiment 1, and to them Al—SiC metal plates were screw-fastened likewise as in Embodiment 2. Holders in which, however, the amount of warpage in the bonding jig was varied as indicated in Table VI to vary the warpage in the retaining face of the ceramic susceptor were prepared, and their temperature uniformity at 500° C. was measured likewise as in Embodiment 1. The results are set forth in Table VI.

TABLE VI

| | | Al—SiC | | | | |
|---|---|---|---|---|---|---|
| | AIN outer | thickness | | Warpage | Fastening | Temp. uniformity |
| No. | dia. (mm) | (mm) | Porosity (%) | (μm) | method | (%) |
| 21 | 350 | 10 | 0.01 | 100 | Screw fastening | ±0.5 |
| 22 | 350 | 10 | 0.01 | 400 | Screw fastening | ±0.8 |
| 23 | 350 | 10 | 0.01 | 600 | Screw fastening | ±0.98 |

Temperature uniformity with whichever of the holders was within ±1.0%, but compared with No. 2 of Embodiment 2, the greater the warpage in the ceramic susceptor the poorer than ±0.45% was the temperature uniformity. Here, in instances where whichever of the holders was put to work, generation of neither metal impurities nor particles could be identified.

Embodiment 9-AlN ceramic susceptors were prepared in the same way as in Embodiment 1. Except for utilizing instead of the Al—SiC metal plate an Mo plate of 140 W/mK thermal conductivity, a Ni plate of 94 W/mK thermal conductivity, and a stainless steel (SUS) plate of 15 W/mK thermal conductivity—each commercially available—holders were prepared by screw-fastening the plates to the ceramic susceptors likewise as in Embodiment 2. The temperature uniformity at 500° C. of each holder was measured in the same way as in Embodiment 1. The results are set forth in Table VII.

TABLE VII

| | | Thermal | | Temp. |
|---|---|---|---|---|
| | | conductivity | Fastening | uniformity |
| No. | Substance | (W/mK) | method | (%) |
| 24 | Mo | 140 | Screw fastening | ±0.48 |
| 25 | Ni | 94 | Screw fastening | ±0.70 |
| 26 | SUS | 15 | Screw fastening | ±0.95 |

Temperature uniformity with whichever of the holders was within ±1.0%. Here, in instances where whichever of the holders was put to work, generation of neither metal impurities nor particles could be identified.

### COMPARATIVE EXAMPLE 1

The same AlN ceramic susceptor and Al—SiC metal plate as with No. 2 in Embodiment 2 were utilized. Oppositely to No. 2, the metal plate was arranged on top of the ceramic susceptor, and the temperature uniformity at 500° C. was measured in the same way as in Embodiment 1. The result was the same ±0.45% temperature uniformity as that of No. 2. Furthermore, an in-line test on 50 12-inch diameter silicon wafers was run likewise as with Embodiment 1, wherein numerous Si-derived particles were generated.

### COMPARATIVE EXAMPLE 2

The same AlN ceramic susceptor as No. 1 of Embodiment 1 was utilized, but without the metal plate, and its temperature uniformity at 500° C. was measured in the same way as in Embodiment 1. The result was an extraordinarily poor temperature uniformity of ±1.2% in contrast to the ±0.5% of No. 1, which confirmed the efficacy of metal plate. It is to be noted that generation of neither metal impurities nor particles could be identified.

According to the present invention as given in the foregoing, by arranging a metal plate on a wafer-holder ceramic susceptor opposite its retaining face the temperature uniformity of the retaining face can be enhanced. Installing a holder of this sort into semiconductor manufacturing devices and liquid-crystal manufacturing devices affords semiconductor as well as liquid-crystal manufacturing devices of excellent productivity and yield.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A holder for semiconductor as well as liquid-crystal manufacturing devices, the holder comprising:
a ceramic susceptor having a retaining side for retaining an object to be processed;
a resistive heating element incorporated in said susceptor; and
a metal plate arranged on said susceptor opposite said retaining side.

2. A holder as set forth in claim 1, wherein said metal plate and said ceramic susceptor are fastened by bonding, screws, snug-fitting, or vacuum adhesion.

3. A holder as set forth in claim 1, wherein the resistive heating element is present beyond the middle in the thickness direction of said susceptor, toward the side opposite said retaining side.

4. A holder as set forth in claim 1, wherein the ceramic of said ceramic susceptor is any one selected from Al₂O₃, SiO₂, B₄C and BN.

5. A holder as set forth in claim 1, wherein the ceramic of said ceramic susceptor has a thermal conductivity of 100 W/mK or more.

6. A holder as set forth in claim 5, wherein the ceramic of said ceramic susceptor is any one selected from AlN, SiC and Si₃N₄.

7. A holder as set forth in claim 1, wherein the metal of said metal plate has a thermal conductivity of 100 W/mK or more.

8. A holder as set forth in claim 7, wherein said metal is any one selected from Al—SiC, Cu—W and Cu—Mo.

9. A holder as set forth in claim 1, wherein the thickness of said metal plate is thicker than the thickness of said ceramic susceptor.

10. A holder as set forth in claim 1, wherein the diameter of said ceramic susceptor is 200 mm or more.

11. A holder as set forth in claim 1, wherein the porosity of the ceramic of said ceramic susceptor is 0.03% or less.

12. A holder as set forth in claim 1, wherein said retaining side has a warpage of 500 □m or less.

13. A semiconductor manufacturing device in which the holder of claim 1 is installed.

14. A liquid-crystal manufacturing device in which the holder of claim 1 is installed.
